(19) United States
(12) Patent Application Publication
(10) Pub. No.: US 2005/0147411 A1
(43) Pub. Date: Jul. 7, 2005

(54) Optical reservation-based network switch fabrics

(75) Inventors: Claude Hamou, Palo Alto, CA (US); Shlomo Shachar, San Francisco, CA (US); Oren Moshe, San Francisco, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Matisse Networks

(21) Appl. No.: 11/052,783

(22) Filed: Feb. 9, 2005

Related U.S. Application Data
(63) Continuation-in-part of application No. 10/157,871, filed on May 31, 2002.
(60) Provisional application No. 60/367,786, filed on Mar. 28, 2002.

(51) Int. Cl. H04B 10/20

(52) U.S. Cl. 398/59

(57) ABSTRACT

A method of communicating data over a network having a plurality of nodes thereupon is disclosed. The method includes reserving bandwidth for each node of the plurality of nodes and receiving data at a first node of the plurality of nodes, where the data includes a destination address on the network for the data. The method also includes allocating the received data on a wavelength associated with a destination node of the plurality of nodes and directing the allocated data to the destination node at the associated wavelength. The destination node is determined based on the destination address.

### REFERENCE TO RELATED APPLICATIONS

This is a continuation-in-part of application No. 10/157,871, filed May 31, 2002, where that application claims priority of United States Provisional Patent Application Ser. No. 60/367,786, filed on Mar. 28, 2002. The contents of the above applications are hereby incorporated by reference.

### BACKGROUND OF THE INVENTION

1. Field of the Invention

The present invention relates to networks, such as Local Area Networks (LANs) and access optical networks. Such networks can occur within an enterprise and the present invention is also directed to fabrics coordinating traffic on those networks. In particular, the present invention for direct all-optical routing that allows for data to be switched between nodes.

2. Description of Related Art

Fiber-optic infrastructure is a vital part of today's rapidly changing worldwide networks. The drive for interconnectivity as well as the exponential growth in data traffic, as a result of new applications, requires the adoption of new optical solutions. Carriers and service providers are looking to increase their revenue by delivering new services such as storage area networks and IP based services to their customers. New technologies that can leverage the existing network, as well as increase the economic viability of new network applications, are needed. New market opportunities and the recent advances in optical technologies (such as wavelength division multiplexing, tunable lasers and high speed optical/electronic components) have yielded new developments in the optical networks area.

Traditionally, optical networks were used mainly in long-haul area networks. Today, however, new optical networks are being introduced in the regional, metropolitan and the local access area networks, including in enterprises. The long-haul area networks use a fiber-optic infrastructure to create large data pipes between two distanced points. Contrastingly, the new optical networks are facing different demands.

Optical networks in the regional, metropolitan and the access area networks require a sustained, high bandwidth, while maintaining mesh connectivity and supporting multiple services and multiple classes of service. For example, metropolitan area networks can transport voice traffic, SAN traffic and other IP traffic. Voice traffic demands low bandwidth, with a guaranteed bandwidth, while SAN traffic is delay sensitive and is burst traffic. An IP traffic class of service is application dependent. Optical network are required to aggregate multiple types of data and transport while keeping the required quality of service.

Communication networks can be divided into two general types: circuit-switched networks (typically used for telephony traffic) and packet-switched networks (typically used for data traffic). Circuit-switched networks (like SONET or SDH) are networks wherein connections between nodes are fixed, whether data are crossing the connection or not. Each connection in a circuit-switched network has a constant-bandwidth. Packet-switched networks, on the other hand, are connectionless networks, wherein data is transmitted in a burst mode. The benefit of packet-switched networks is that bandwidth is used more optimally. However the connectionless networks lack the ability to reserve bandwidth, and support a hard quality of service. Moreover the statistic aggregation of packets can create an overload situation, in which packets may suffer large delays or even data loss.

All optical networks are basically packet-switched networks, in which routing packets from a source node to a destination node is done optically, without the need for optical-electrical conversions outside the source and destination nodes. A sub-group of the all-optical networks is the all-optical multi-ring networks. Optical multi-ring networks are based on a fiber ring topology, in which the fiber-ring is a shared optical medium. Nodes, located around the fiber-ring, are equipped with optical receiver, fixed to a unique wavelength, and with an ultra-fast tunable transmitter. In a multi-ring optical network each wavelength is associated with a specific node. Transmitting packets to destination node is done by a tunable-laser tuned to the destination wavelength. Logically the network is a multi-ring topology, which allows any node to address any other node simply by changing its transmitter wavelength to the target's receiver wavelength without electrical routing.

As in other shared media topologies, in the packet switched multi-ring topology, the problem of collisions when accessing the fiber must be addressed. There are two main approaches to resolve packets collision problems: 1) an Ethernet-like scheme where carrier detection is applied or 2) a synchronous system where collision can't happen since each participant (node) has a reserved time when it can use the media. By giving each node a required time or time frame in which it can use the media, a synchronizing scheme between all the nodes needs to be implemented. In the case of optical slotted ring dynamic networks, packets can be transmitted to the fiber in dedicated time slot boundaries. The optical media poses special problems that need to be overcome with respect to the slot synchronization.

Furthermore, since packets can be transmitted from any one node to any other node on the fiber ring, frequency, phase and the position of the payload inside the time slot cannot be guaranteed. Synchronizing on the signal frequency and phase, and recognizing the payload should be done within a fraction time of the packet duration and calls for fast synchronization solutions. In addition, in many networks that utilize optical fiber, the optical signals must be “translated” into electrical signals in order for the packet data to be switched. Such a process can slow down the throughput of the switching system.

Thus, there is a need for a synchronization scheme that addresses the problems discussed above for use in dynamic optical networks. There is also a need for a process and system that overcomes the problem of time slot synchronization between the nodes on the fiber ring so it is possible for each node to access the fiber without collisions. Furthermore, in the context of this synchronization method, there is also a need to define a method to recover the packet's data and clock in an ultra-fast recovery time. Also, there is a need for a switching system that can take the place of a semiconductor-based switch.

### SUMMARY OF THE INVENTION

This invention seeks to overcome the drawbacks of the above-described conventional network devices and methods. The present invention provides for a new synchronization method for an optical slotted ring dynamic network. With this approach, nodes that send packets to the same destination node must access the fiber at a designated time-slot. The synchronizing signal is sent from a master node to the other nodes. The present invention also provides for a burst mode receiver used to receive and process an optical signal. Additionally, the use of a fiber providing the functions of a switch fabric is also disclosed.

According to one aspect of this invention, a method of communicating data over a network having a plurality of nodes thereupon. The method includes reserving bandwidth for each node of the plurality of nodes and receiving data at a first node of the plurality of nodes, where the data includes a destination address on the network for the data. The method also includes allocating the received data on a wavelength associated with a destination node of the plurality of nodes and directing the allocated data to the destination node at the associated wavelength. The destination node is determined based on the destination address.

Additionally, the method may be applicable to an optical fiber ring network and the bandwidth is resolved on the optical fiber ring network for each node. Also, the data may be multiple data packets having multiple destination addresses on the network, each data packet may be allocated on a node wavelength associated with a destination node and the allocated data packets are directed to destination nodes at associated node wavelengths. Also, the step of allocating the received data may include tuning a fast tunable laser to the wavelength associated with a destination node. Additionally, the step of receiving data at a first node of the plurality of nodes includes tuning a fast programmable receiver to a wavelength associated with a particular node associated with a portion of the reserved bandwidth.

In addition, data may be received at the first node of the plurality of nodes at a wavelength associated with the first node. Also, the step of allocating the received data may include tuning a fast tunable laser to a plurality of wavelengths associated with destination nodes when the data includes multiple destination addresses on the network for the data. Also, an integer number of slots may be achieved on the network by changing the optical length of the optical fiber ring network, where that change may occur by adjusting an optical delay line. Additionally, the step of allocating the received data may include managing traffic on the network based on congestion at the plurality of nodes.

In another aspect of the invention, a communications node for communicating data over a network having a plurality of nodes thereupon is disclosed. The node includes reserving means for reserving bandwidth for each node of the plurality of nodes and receiving means for receiving data at a first node of the plurality of nodes, where the data includes a destination address on the network for the data. The node also includes allocating means for allocating the received data on a wavelength associated with a destination node of the plurality of nodes and directing means for directing the allocated data to the destination node at the associated wavelength. The allocating means is configured to determine the destination node based on the destination address.

In another aspect of the invention, a communications node for an optical fiber network is disclosed. The node includes a receiver for receiving optical data from source nodes, a transmitter for transmitting optical data to destination nodes and a media access controller which determines a slot clock based on a system clock signal received by the receiver. The receiver is of a first type that is one of a fixed wavelength type and a tunable wavelength type, the transmitter is of a second type that is one of the fixed wavelength type and the tunable wavelength type, where the first and second types are not the same. Also, the media access controller is configured to allocates and direct data, received from a plurality of nodes on the optical fiber network, on a wavelength associated with a destination node determined for the data.

These and other objects of the present invention will be described in or be apparent from the following description of the preferred embodiments.

### BRIEF DESCRIPTION OF THE DRAWINGS

For the present invention to be easily understood and readily practiced, preferred embodiments will now be described, for purposes of illustration and not limitation, in conjunction with the following figures:

FIG. 1 illustrates all-optical multi-ring network with four nodes, and a schematic implementation of node #2, where node #2 drops wavelength #2, while other wavelengths pass thru the node;

FIG. 2 illustrates the slots on the slotted network over an optical ring, where the slots are rotating in the ring at one direction;

FIG. 3 shows the packet position inside the time slot;

FIG. 4 illustrates the case where the number of slot on the ring is not of an integer number of slots, the tail slot overlap the head slot;

FIG. 5 illustrates the master node PHY, according to one embodiment of the present invention, responsible of the synchronization channel, and the slots locking mechanism;

FIGS. 6a and 6b illustrate optical delay lines (ODL), with FIG. 6(a) illustrating schematically a parallel ODL and FIG. 6(b) illustrating schematically a serial ODL;

FIG. 7 illustrates a regular node PHY, according to one embodiment of the present invention, responsible of the synchronization channel, and the slots locking mechanism;

FIG. 8 illustrates a delay control process that compensates accumulated delay for the broadcast wavelength;

FIG. 9 illustrates a Synchronous burst mode receiver diagram, according to one embodiment of the present invention;

FIG. 10 illustrates one implementation of a 10GHz clock phase shifter according to one aspect of the present invention;

FIG. 11a illustrates an all-optical multi-ring network with four nodes, where FIG. 11b illustrates that both the receiver and the laser at each node are tunable, according to one embodiment of the invention; and

FIG. 12 illustrates the use of an optical fiber ring as a switch fabric, according to one aspect of the present invention.

### DETAILED DESCRIPTION OF PREFERRED EMBODIMENTS

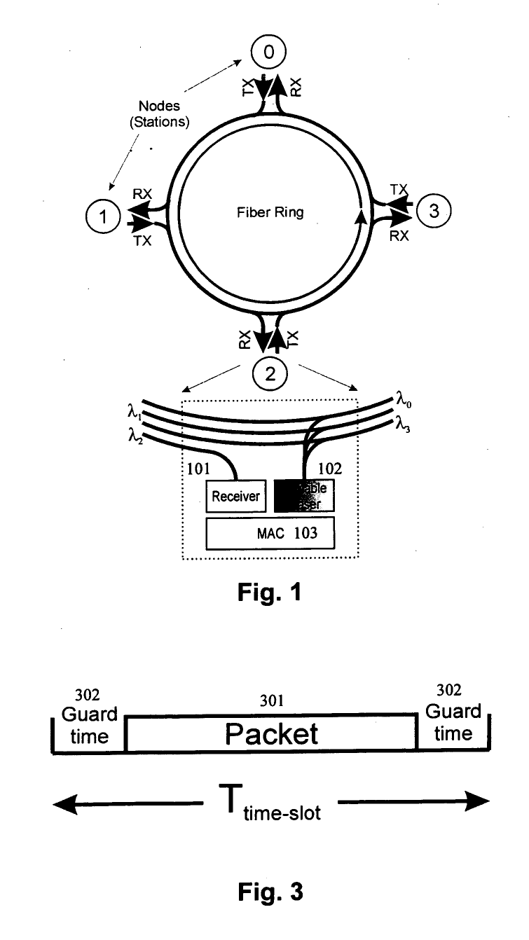

The invention is directed, in part, to a synchronization scheme for an all-optical network, in which nodes are equipped with an ultra-fast tunable laser transmitter and a fixed receiver. As shown in FIG. 1, each node station has a receiver 101 tuned to a specific wavelength and a tunable laser 102 for transmitting to the other nodes. Both the laser and receiver are in communication with the Media Access Control (MAC) 103. According to the present invention, the synchronization scheme defines any one of the nodes as a master-node (or referred to as the origin-node). The master-node can be any of the network nodes and may perform additional tasks such as synchronization signal distribution and reservation algorithm execution.

As discussed above, optical packet networks can be divided into two types: slotted networks and unslotted networks. Slotted networks are synchronous networks in which all the packets have the same fixed size and are transmitted inside fixed time slots. On some systems, the time slot's duration can be larger then the packet transmission duration due to guard times and headers. Unslotted networks are asynchronous networks in which the packets can have a variable size and are not transmitted within a time slot. The present application has particular relevance to optical slotted packet networks based on an optical ring topology and proposes a method to synchronize such a network.

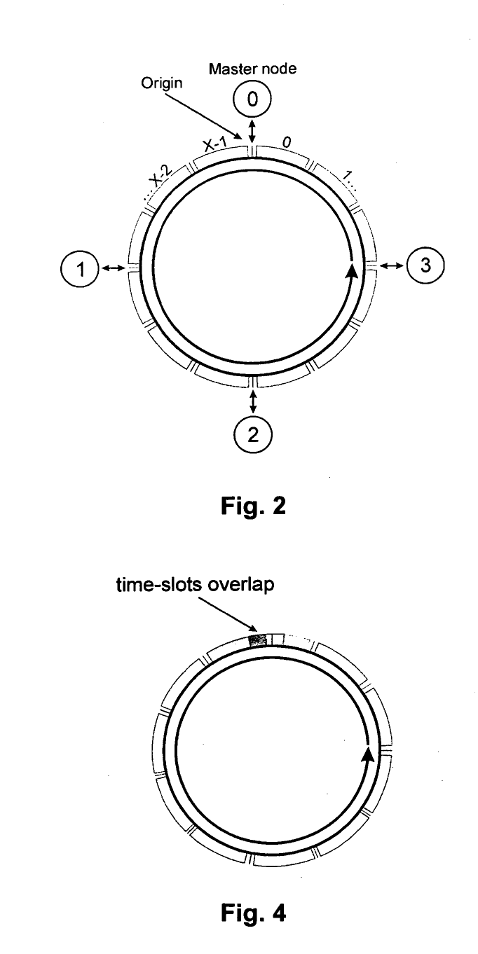

In a slotted network topology over an optical ring, slots are rotating in the ring in one direction, as shown by the circular arrow in FIG. 2. Nodes add packets to the rotating slots in the transmission direction and drop packets from the slots on the receiving direction.

In this access method, a global synchronization scheme is needed in order for nodes to be synchronized on the slots boundaries. In a synchronous slotted ring the number of slots on the ring must be an integer number. In the case where the number of slot on the ring is not of an integer number of slots, the tail slot will overlap the head slot, as shown in FIG. 4. Overlapping makes it impossible for the scheme to be collision free.

Since all the nodes are synchronized on a global slot clock, a synchronization jitter between nodes can be created. Moreover, when the slot is used to transmit packets with different wavelengths, a “walk-off” between packets is created, due to the chromatic dispersion. In order to avoid packet overlap, guard times are required. FIG. 4 shows the packet 301 positioned inside the time slot. A guard time 302 is placed before and after the data packet payload inside a time slot.

Since each node receives packets from different destinations, the packet phase and the position of the packet inside the slots is not precisely known. A burst receiver is needed at the receiving node for phase locking and to determine the packet's position in the slot. The burst receiver uses a preamble header, which each packet has; where the preamble header contains a “barker” to mark the beginning of the payload.

The system can be implemented with or without a single system clock. On a synchronized ring operating with a single system clock, one node (master node) broadcasts a system-clock signal that is locked onto by all the other nodes. The system-clock is used, by each node, for transmitting data to other nodes, for sampling the received data signals and for slot synchronization. When the system is implemented with no single system clock, the broadcast channel can be used for slot synchronization alone.

In order to keep the slots from overlapping, slots boundaries can be determined by a single source. In the case where the system is implemented using a single system clock, the master node transmits the time-slot clock by transmitting a cyclic series with the slots-clock cycle. At the slave nodes, a correlator tuned to this series can be used for recovering the time-slot clock. The transmitted series propagates around the ring and returns to the master node. A locking mechanism at the master node then changes the time-slot duration to eliminate the slots overlapping. The time-slot duration is controlled through the change in the series sequence phase. This is done by changing the sequencer reset times.

In order to achieve an integer number of time slots on the ring, the size of the physical ring can be changed (by using a configurable optical delay line), or the packet size could be changed. On rings having large lengths, where there is a high number of slots on a ring, a small change in the packet size is multiplied by the number of slots. In this case, a higher guard time could absorb the packet size change. On shorter rings, changing the guard time is not enough, and the payload size must be changed in order to keep a constant bit rate. In this embodiment, the Master node is responsible of measuring the ring length and then to determine the optical delay line configuration and the time-slot size.

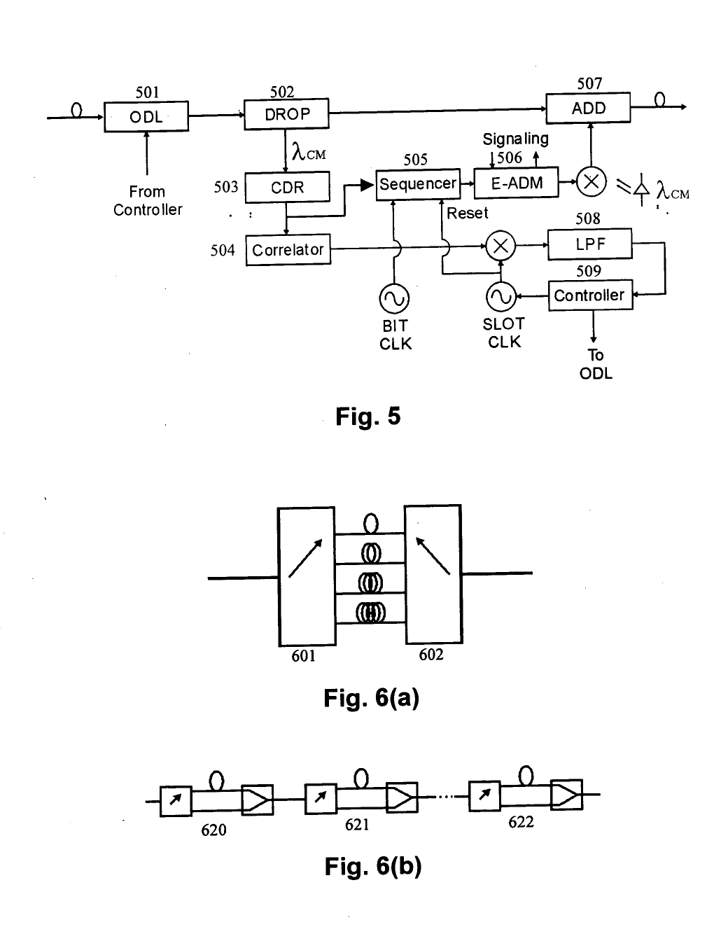

In addition to the regular PHY tasks, the PHY at the master node should maintain an integer number of slots on the fiber. The PHY at the master node has a locking mechanism to accomplish this task. FIG. 5 illustrates the master node PHY, according to one embodiment of the present invention. The first stage provides for a rough adjustment of the ring length, where the adjustment is performed through a tunable optical delay line (ODL) 501. The second stage is for small adjustment and is done by a Phase Locked Loop (PLL) that is locked to the slot clock signal. The PLL is made up of, in this embodiment, of a drop component 502 that takes part of the signal that is processed by the Clock and Data Recovery (CDR) component. The output from the CDR is sent to the correlator 504 and to the sequencer 505. The correlator 504 produces a slot clock signal and provides this signal to a phase detector where it is multiplied with the output of a voltage control oscillator (VCO). The output of the phase detector is sent to a low pass filter 508 and then to a controller 509 to produce a clean slot clock without the jitter that may be present in the derived slot clock signal. The clean slot clock and the bit clock are input into a sequencer and the sequencer outputs a signal to the add/drop multiplexer 506 (ADM). The multiplexer allows for a signal specific to that node to be extracted or added. The multiplexed signal is sent to a modulator along with a signal from the light source tuned to the broadcast wavelength. The new signal is added back to the ring to be received by the next node.

Sending the time-slot clock on the same phase as the received signal assures that slots are not overlapping. The PLL adjustments are used to set the time-slot duration. The duration of the time-slot clock is changed by changing the series sequence phase (by resetting the sequence). A signaling channel can be added over the broadcast wavelength as well using an electrical add and drop.

In the case where the bit clock is not distributed, the time-slot clock is transmitted directly over the broadcast wavelength and a simple PLL can be used to recover the clock.

The ring length and the slot size determine the slot clock adjustments. Given that the residue (the excess partial time slot on the ring) is divided between all of the slots on the ring, a clock adjustment is needed, where the residue is divided between each of the number of slots. Since on small rings the needed adjustment might be too large for the system needs, it is possible to artificially change the original ring size. This can be done, for example, at the master node using a tunable optical delay line.

An example of a tunable optical delay line illustrated in FIG. 6(a) has four delays positions: none, ¼ slot, ½ slot and ¾ slot. This delay line can be used to reduce the residue. By changing the source clock, the remaining residue will be then eliminated. Hence, the maximum clock adjustment can be reduced by a factor of four.

In one embodiment, a Parallel Optical Delay Line may be used, as illustrated in FIG. 6(a). The Parallel Optical Delay Line two 1:N optical switches switch between N fibers of 0 to 1 time slot lengths. The two switches have to get the same control. The granularity of this ODL is dependent on the number of ports each optical switch has.

In another embodiment, a Serial Optical Delay Line may be used. A Serial Optical Delay Line, as illustrated in FIG. 6(b), can have N stages; each stage can include a 1:2 switch, a delay line and a combiner. By changing the state of each of the N switches, 2^{N} different delays are possible. A relatively high Insertion Loss, however, is one penalty in this configuration.

The system can be implemented with or without a globally synchronized bit clock. When the bit clock is distributed, slot synchronization is accomplished by transmitting a repeating sequence over the broadcast bit clock channel, onto which each node locks. In the case the bit clock is not distributed, the slot clock is transmitted directly over the broadcasted channel. In both cases, the broadcast wavelength is dropped at each node, reconstructed and transmitted again in a daisy chain manner.

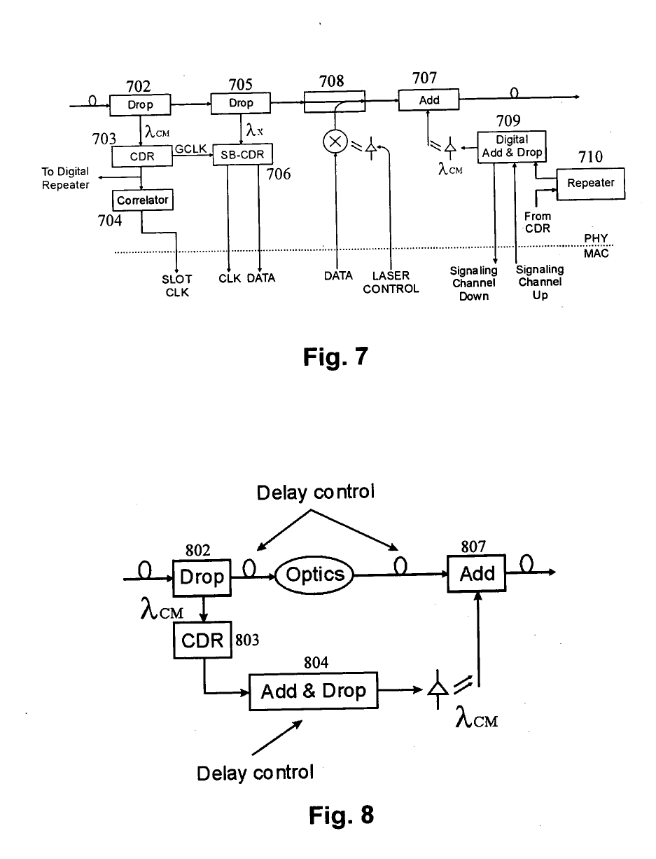

The PHY at the regular nodes is illustrated in FIG. 7. In the first stage the System Clock and the Slot Clock are recovered. The signal is received at the drop 702 and a conventional CDR 703 extracts the Data & the CLK from the broadcasted wavelength. The clock extracted is used as the system clock, and the data is used to extract the Slot clock. The data transmitted over the broadcast wavelength is a cyclic series with a cycle of the Slot Clock rate. A correlator 704 tuned to this series is used for recovering the slot clock.

In the next stage, the node's specific wavelength is dropped 705 and sampled using a Synchronous burst mode receiver (SB-CDR) 706. The SB-CDR generates a clock synchronous to the data received using a phase shifter. The use of a phase shifter assures a fast locking time. Next, packets are added 708 to the fiber using the tunable laser, and on the last stage, the broadcast wavelength is retransmitted 707 after it has passed through an O-E-O conversion and signaling data is added and dropped 709 & 710.

As can be seen, the broadcast wavelength is recovered at each node, and retransmitted in a daisy-chain manner. Since the data is recovered and retransmitted, the internal delay of the electronics might cause a phase shift of up to one broadcast wavelength clock. This delay is accumulated at each node on the ring, and should be considered in the packet guard time. Alternatively, this delay can be minimized through the use of an appropriate delay control, either by optics or an electrical delay, as shown in FIG. 8.

In the case where the Slot Clock is transmitted directly over the broadcast wavelength, a simple PLL can be locked over the returning signal. The slot clock, transmitted by the master node, propagates around the ring to all the nodes. Each node drops the clock signal wavelength, and converts the optical signal to electrical. Since the slot clock needs to have low jitter/noise characteristics, a phase-lock-loop (PLL) can be used to recover a clean clock. In any of the methods, the recovered slot clock is used to time the node transmitter and receiver, and thus avoid overlapping between slots.

Since the system bit clock is distributed and each node transmits the packet bits using a clock derived from the system clock, the receiver doesn't need a frequency lock. Bit synchronization can be achieved by merely shifting the clock phase using a phase shifter based burst receiver. Shifting the phase alone can be done much faster than the frequency and phase locking that the traditional PLL receiver does.

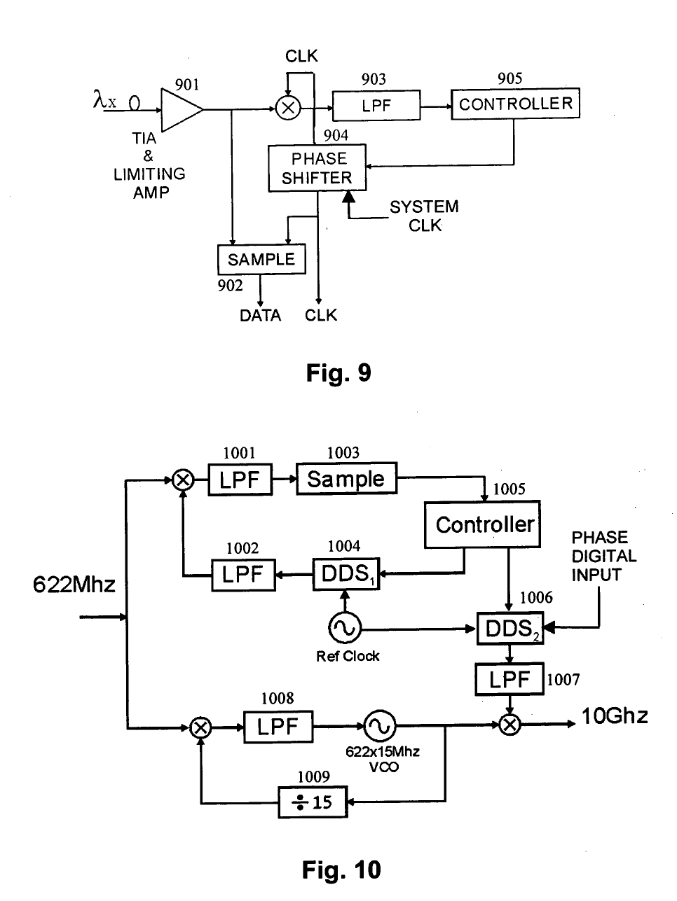

An example of a Synchronous burst mode receiver is illustrated in FIG. 9. Since the system clock is known, the data frequency is known as well. The SB-CDR uses the system clock as a reference for the phase deviation measurement. The phase deviation measurement is used in adjusting the phase shifter and the phase-shifted clock is then used for sampling the data. The SB-CDR phase locking is done in two stages. In the first stage the phase shifter is shifted directly to the calculated phase. In the second stage the correct phase is kept during the packet transmission by slower corrections. The input signal is limited by a limiting amplifier 901 and the output is sent to both the phase detector and the sample unit 902. The phase detector operates on a clock signal from the phase shifter 904 with the input signal. The output of the phase detector is sent to a low pass filter 903 and to a controller 905 for the phase shifter. The phase-shifted clock is also sent to the sample unit 902 to sample the data.

Normally, a source node transmits a packet within the time-slot boundaries, using the appropriate guard times. However, due to the fact that destination node receives packets from multiple source nodes; the packet's position inside the time-slots is not known. In order to recognize the packet payload, a “barker” is placed between the preamble and the packet payload. The digital receiver recognizes the barker, and extracts the payload.

On a synchronized ring operating with a single system clock, one node (master node) broadcasts a system-clock signal that is locked onto by all of the other nodes. The system-clock is used, at each node, for transmitting data to other nodes and for sampling the received data signals. However, the nodes are located at different distances from each other and have different electrical/optical inner-delays; this means that although all the source nodes transmit signals using the same clock, the destination node gets a phase shifted signal depending on the source node location/delay.

In order to handle the shift delays and avoid the need for a burst receiver and/or the penalty of a PLL locking time, the receiving nodes can use a phase-shifter scheme. In the phase-shifter scheme, the bit clock frequency is known. The known frequency clock is shifted by the phase shifter to the correct bit clock phase. The phase shift needed is determined from a phase detector. The correct phase is kept during the packet transmission by slow corrections.

An embodiment of a 10GHz clock phase shifter implementation is illustrated in FIG. 10: One Direct Digital Synthesizer (DDS) 1004 is used as a VCO in a Phase Locked Loop. Its frequency and phase are locked to the 622 MHz system-clock. A second DDS 1006 receives the same control words, from the controller 1005, as the first DDS so its output is the same as the first DDS. By adding a constant value to the control words, the second DDS keeps track of the input frequency, but with a different phase. The phase-shifted output is then multiplied with a 15 x system clock, creating a phase controlled 10 Gbit clock.

Dense Wavelength Division Multiplexing (DWDM) is an optical technology used to increase bandwidth over existing fiber optic backbones. DWDM works by combining and transmitting multiple signals simultaneously at different wavelengths on the same fiber. In effect, one fiber is transformed into multiple virtual fibers. Therefore, eight optical carrier-48 signals may be multiplexed into one fiber, to increase the carrying capacity of that fiber from 2.5 Gb/s to 20 Gb/s.

One advantage to DWDM is that it is protocol and bit-rate independent. DWDM-based networks can transmit data in Internet Protocol (IP), Asynchronous Transfer Mode (ATM), Synchronous Optical Network/Synchronous Digital Hierarchy (SONET/SDH), and Ethernet. Therefore, DWDM-based networks can carry different types of traffic at different speeds over an optical channel. From a QoS (Quality of Service) stand point, DWDM-based networks create a lower cost way to quickly respond to customers' bandwidth demands and protocol changes.

In one embodiment of the present invention, the use of Reservation Based method, as discussed above, a DWDM fiber optical ring may be used to achieve the functionality of a switch. The present invention uses fast tunable lasers and/or fast programmable receivers to convert the optical fiber ring into a switch fabric.

All the nodes in the system are connected through the optical fiber, each node has a dedicated wavelength assigned to it or programmed while connected to the fabric. Using the reservation based method, bandwidth is reserved to each node in the fabric and the direction of traffic on separate wavelength intended to different nodes is resolved. Thus, the present invention has the ability to direct traffic simultaneously from different sources to different destination nodes by the allocation of the appropriate data on the wavelengths assigned to each nodes in the system is achieved.

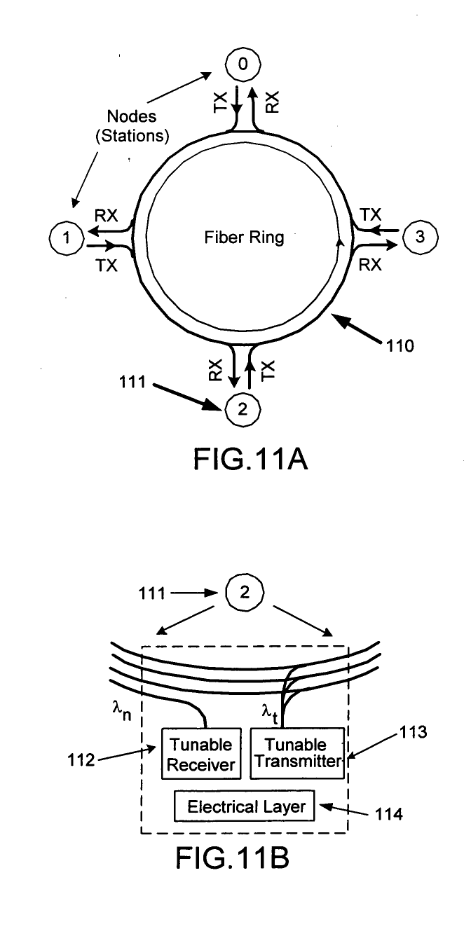

The reservation-based method provides a scheduling mechanism to control the transmission of the appropriate wavelengths while using a tunable laser and/or the reception of the correct wavelength while using programmable receivers. Such a system is illustrated in FIGS. 11a and 11b. The invention is therefore directed, in the embodiments discussed below, to a system and method for all-optical switching system such as network or fabric-switch, in which optical elements 111 are equipped with tunable laser transmitter 112 and/or tunable receiver 113, as shown in FIG. 17B. Both tunable elements are controlled by the electrical layer 114.

Although using two tunable elements does not improve the system dynamic allocation it simplifies the system deployment. Systems which are based on fixed elements (transmitters or receivers) are required to be designed in a way that no two elements with the same configuration will be connected to the same network. By using only tunable elements the network can configure itself during the initialization process avoiding the pre-design.

Converting wavelengths to specific nodes addresses provides the needed mechanism to solve the addressing process, while the synchronization allows the use of optical fibers at different length. Thus, the method of using reservation map to control tunable lasers to transmit and fixed receivers, or programmable receivers and fixed lasers to transmit, combined with a synchronization mechanism are used to achieve the functions of a switch fabric. These functions may include bandwidth allocation per node and the simultaneous transmission and reception of data on different node in a system which includes a plurality of nodes. The switch fabric also provides for the ability to replace a pre-determined routing table, which defined the traffic source and destination digital addresses, with wavelengths, where this is used as an alternative to traditional implementation of this function in switches using digital solid state semiconductors.

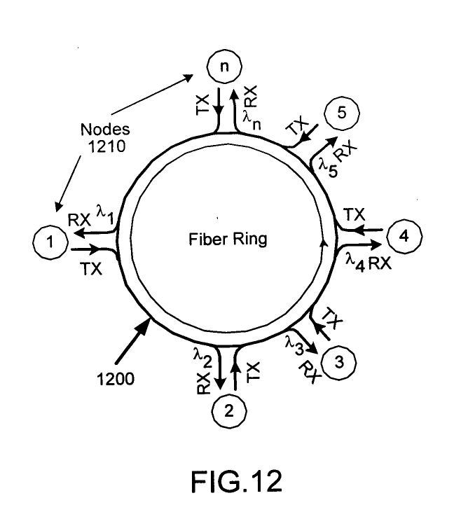

A reservation-based optical switch fabric is generally illustrated in FIG. 12. All the nodes 1210 in the system are connected through the optical fiber 1200, with each node having a dedicated wavelength assigned to it or programmed while connected to the fabric. As illustrated in FIG. 12, node 3 has assigned thereto a wavelength 3, such that node 3 need only be concerned with signals a wavelength the same as its assigned wavelength. Using the reservation based method, bandwidth is reserved to each node in the fabric and the direction of traffic on separate wavelength intended to different nodes is resolved.

Thus, the present invention has the ability to direct traffic simultaneously from different sources to different destination nodes by the allocation of the appropriate data on the wavelengths assigned to each nodes in the system is achieved. Such functionality has import for data that arrives at a node and needs to be multicast or broadcast to other nodes. In each case, a tunable laser is used to send out the received data on a plurality of wavelengths corresponding to the proper destination nodes.

Traditional implementation of the functions described above using solid-state semiconductors consist of combining the functions of switching traffic based on source and destination addressing, traffic management and traffic scheduling. In the present embodiment of the invention, the tunable lasers and receivers, together with the synchronizing process, provide the equivalent to layer 2 scheduling, forwarding and linking of data.

Usually a crossbar function is implemented to cover directing traffic from different sources to different destination and the traffic scheduler combined with the traffic management function, are the functions need to deliver traffic based on priority and demand of bandwidth. The implementation is based on separate solid state semiconductors or having these some of all of these functions integrated in one of more semiconductor devices. These functions can also include the dropping of packets because of congestion at ports of the switch, on a priority or non-priority basis. Traditional switch fabrics also allow for traffic arriving or departing from a port to be monitored by mirroring packets to another port where the monitoring occurs.

The approach of the present embodiment of the invention is the ability to direct wavelengths within a single fiber optic wire to different destinations. The present embodiment also allows for the use of the reservation map algorithm, which provides the control mechanism to the fast tunable laser to select the appropriate wavelength.

The monitoring of data through mirroring of data to another node can be easily accomplished through the system provided by the present invention. As an example, suppose that packets received by node 4, in FIG. 12, are to be monitored by mirroring those packets to node 5 also. In a traditional semiconductor system, extra copies of the packets destined for node 4 would need to be replicated and forwarded to node 5. In the present invention, the receiver in node 5 would merely need to be tuned to λ₄ such that it can also receive the same packets that are received by node 4.

This embodiment provides for a completely new approach for the implementation of these switch fabrics, achieving a new level of distribution over long and short distances and a cost efficiency advantage due to the ability of building the switch in a scalable manner. Implementation using semiconductor-based switches forces the centralization of the fabric into one specific rigid location. With the optical fiber switch mechanism of the present invention, the switching need not occur in a central location and can be spread out to portions of the network where the switching functions may be most appropriate.

In summary, the invention is directed to a reservation-based media access controller which is capable of providing a full reservation optical network. The invention is also directed to an optical network which implements the full reservation algorithm, and methods of providing full reservation optical communication utilizing reservation of time-slots and wavelengths. Various configurations of an optical network and the nodes thereof can be provided, as discussed herein, and the media access controller can be created based upon a plurality of discrete components configured to form a functioning unit, and can also be formed on a single semiconductor substrate.

Although the invention has been described based upon these preferred embodiments, it would be apparent to those of skilled in the art that certain modifications, variations, and alternative constructions would be apparent, while remaining within the spirit and scope of the invention. In order to determine the metes and bounds of the invention, therefore, reference should be made to the appended claims.

1. A method of communicating data over a network having a plurality of nodes thereupon, said method comprising the steps of:
reserving bandwidth for each node of said plurality of nodes;
receiving data at a first node of said plurality of nodes, where the data includes a destination address on the network for the data;
allocating the received data on a wavelength associated with a destination node of said plurality of nodes; and
directing the allocated data to the destination node at the associated wavelength;
wherein the destination node is determined based on the destination address.

2. A method as recited in claim 1, wherein said network comprises an optical fiber ring network and said step of reserving bandwidth for each node comprises reserving bandwidth on said optical fiber ring network for each node.

3. A method as recited in claim 2, wherein the data comprises multiple data packets having multiple destination addresses on the network, wherein said step of allocating the received data on a wavelength comprises allocating each data packet on a node wavelength associated with a destination node and wherein said step of directing the allocated data comprises directing the allocated data packets to destination nodes at associated node wavelengths.

4. A method as recited in claim 1, wherein said step of allocating the received data comprises tuning a fast tunable laser to the wavelength associated with a destination node.

5. A method as recited in claim 1, wherein said step of receiving data at a first node of said plurality of nodes comprises tuning a fast programmable receiver to a wavelength associated with a particular node associated with a portion of the reserved bandwidth.

6. A method as recited in claim 1, further comprising receiving data at said first node of said plurality of nodes at a wavelength associated with the first node.

7. A method as recited in claim 1, wherein said step of allocating the received data comprises tuning a fast tunable laser to a plurality of wavelengths associated with destination nodes when the data includes multiple destination addresses on the network for the data.

8. A method as recited in claim 2, further comprising achieving an integer number of slots on the network by changing a number of time slots on the optical fiber ring network.

9. A method as recited in claim 8, wherein the step of changing the optical number of time slots on the optical fiber ring network comprises dynamically measuring an optical length of the optical fiber ring and setting the number of time slots based on the measuring of the optical length.

10. A method as recited in claim 1, wherein the step of allocating the received data comprises managing traffic on the network based on congestion at the plurality of nodes.

11. A communications node for communicating data over a network having a plurality of nodes thereupon, comprising:
reserving means for reserving bandwidth for each node of said plurality of nodes;
receiving means for receiving data at a first node of said plurality of nodes, where the data includes a destination address on the network for the data;
allocating means for allocating the received data on a wavelength associated with a destination node of said plurality of nodes; and
directing means for directing the allocated data to the destination node at the associated wavelength;
wherein the allocating means is configured to determine the destination node based on the destination address.

12. A communications node as recited in claim 11, wherein said network comprises an optical fiber ring network and said reserving means comprises means for reserving bandwidth on said optical fiber ring network for each node.

13. A communications node as recited in claim 12, wherein the data comprises multiple data packets having multiple destination addresses on the network, wherein said allocating means comprises means for allocating each data packet on a node wavelength associated with a destination node and wherein said directing means comprises means for directing the allocated data packets to destination nodes at associated node wavelengths.

14. A communications node as recited in claim 11, wherein said allocating means comprises tuning means for tuning a fast tunable laser to the wavelength associated with a destination node.

15. A communications node as recited in claim 1 1, wherein said receiving means comprises tuning means for tuning a fast programmable receiver to a wavelength associated with a particular node associated with a portion of the reserved bandwidth.

16. A communications node as recited in claim 11, further comprising second receiving means for receiving data at said first node of said plurality of nodes at a wavelength associated with the first node.

17. A communications node as recited in claim 1 1, wherein said allocating means comprises tuning means for tuning a fast tunable laser to a plurality of wavelengths associated with destination nodes when the data includes multiple destination addresses on the network for the data.

18. A communications node as recited in claim 12, further comprising means for achieving an integer number of slots on the network by means for changing a number of time slots on the optical fiber ring netvork.

19. A communications node as recited in claim 18, wherein the means for changing the optical number of time slots on the optical fiber ring network comprises means for comprises means for dynamically measuring an optical length of the optical fiber ring and means for setting the number of time slots based on the measuring of the optical length.

20. A communications node as recited in claim 11, wherein the allocating means comprises traffic managing means for managing traffic on the network based on congestion at the plurality of nodes.

21. A communications node for an optical fiber network, said communications node comprising:
a receiver for receiving optical data from source nodes;
a transmitter for transmitting optical data to destination nodes; and
a media access controller which determines a slot clock based on a system clock signal received by the receiver;
wherein the receiver is of a first type that is one of a fixed wavelength type and a tunable wavelength type, the transmitter is of a second type that is one of the fixed wavelength type and the tunable wavelength type, where the first and second types are not the same; and
wherein the media access controller is configured to allocates and direct data, received from a plurality of nodes on the optical fiber network, on a wavelength associated with a destination node determined for the data.

22. A communications node as recited in claim 21, wherein said network comprises an optical fiber ring network.

23. A communications node as recited in claim 22, wherein the data comprises multiple data packets having multiple destination addresses on the network and wherein the media access controller allocates and directs each data packet on a node wavelength associated with the destination.

24. A communications node as recited in claim 21, wherein said transmitter is of the tunable wavelength type and said transmitter is configured to be tuned to the wavelength associated with a destination node.

25. A communications node as recited in claim 21, wherein said receiver is of the tunable wavelength type and said receiver is configured to be tuned to a wavelength associated with a particular node associated with a portion of the reserved bandwidth.

26. A communications node as recited in claim 22, wherein the media access controller determines a slot clock based on a system clock signal achieving an integer number of slots on the network by changing the optical length of the optical fiber ring network.
